(19) United States
(12) Patent Application Publication
(10) Pub. No.: US 2003/0189583 A1
(43) Pub. Date: Oct. 9, 2003

(54) Method and apparatus for representation of video and audio signals on a low-resolution display

(76) Inventors: Artur B. Twarecki, Toronto (CA); Mark Batchelor, Gormley (CA)

Correspondence Address: Mark B. Eisen, Dimock Stratton Clarizio LLP, 20 Queen Street West, Suite 3202, Box 102, Toronto, ON, M5H 3R3, CA

(21) Appl. No.: 10/210,101

(22) Filed: Aug. 2, 2002

(30) Foreign Application Priority Data
Apr. 8, 2002 (CA) 2,380,884

(51) Int. Cl. G09G 5/10

(52) U.S. Cl. 345/691

(57) ABSTRACT

The method for the representation of video and audio signals on a low-resolution display panel, which includes the steps of: scaling the video or audio frame to fit the display panel, quantization of the video or audio signals to predetermined level values, temporal representation of video data by using the pulse density modulation, sending the signal pulses to the display panel. In further aspect the step of temporal representation contains the anti-flickering signal manipulation technique incorporating maximization of separation of the pulses during the pulse density modulation.

### FIELD OF THE INVENTION

The present invention relates to the control systems of the physical display panels. More particularly, it relates to the reproduction of the video and audio signals on a display panel.

### BACKGROUND OF THE INVENTION

The low-resolution display panels such as Vacuum Fluorescent Display, Light-Emitting Diode, Liquid Crystal Display and others are often used for visual representation of numeric data. The goal of current invention was to use the low-resolution displays for visual representation of gray-scaled video and audio signals. The main problem was how to reconcile the two-value states for each pixel on the low-resolution display (only ‘on’ or ‘off’) with requirements to represent the multiple-value gray-scaled data from video sources.

The current invention uses the so-called Pulse Density Modulation to represent gray-scaled video data on the low-resolution display. The property of Pulse Density Modulation is that it conveys the data values by asserting the variable number of pulses in each fixed period of time. This characteristic of Pulse Density Modulation is suitable to transmit the brightness value of each pixel due to the property of human eye to integrate binary (only ‘on’ or ‘off’) brightness pulses over the time to perceive them as the gray-scaled pixels.

The two-dimensional spatial Pulse Density Modulation was used in the prior art for halftoning image rendering systems for printing color and gray-scaled documents. The current invention uses temporal Pulse Density Modulation technique to represent changing-in-time signals.

### SUMMARY OF THE INVENTION

It is an object of the present invention to provide a method and an apparatus for the reproduction of the video and audio signals on a low-resolution display panel.

Unlike prior art methods the method of invention represents the low-resolution frame buffer on a display panel by using the one-dimensional temporal pulse density modulation technique.

According to the method of the invention, the video or audio frames are scaled to fit the low-resolution display panel, signal values are quantized to the predetermined level values, these values are modulated in time using the pulse density modulation technique, and pulses are sent to the display panel.

In further development, for the video signals the quantized values are altered during modulation in the way that after modulation the biggest temporal distance separates each two consecutive pulses. This property allows avoiding an appearance of flickering on the display panel in most cases. To achieve the effect, the pulses' count is incremented starting from the most significant bit and going further to the least significant bit.

An apparatus implementing the proposed method includes the following parts: a Video Signal Modulator, an Audio Signal Transformer, and Display Buffer. The Video Signal Modulator consists of Input Video Buffer, Video Processor, Output Video Frame Buffer, and Pulse Density Modulator. The Audio Signal Transformer contains Audio Processor, Audio Frame Buffer, and Audio Signal Modulator. The Video Signal Modulator has also control logic to perform the anti-flickering processing of signal.

### BRIEF DESCRIPTION OF THE DRAWINGS

FIG. 1 shows the Video and Audio Signals Reproducer.

FIG. 2 describes details of the Video Signal Modulator.

FIG. 3 clarifies the Pulse Density Modulation implementation.

FIG. 4 shows details of the Audio Signal Transformer.

### DETAILED DESCRIPTION OF THE INVENTION

The invention is applicable to the reproduction of the video and audio signals on the low-resolution display panel.

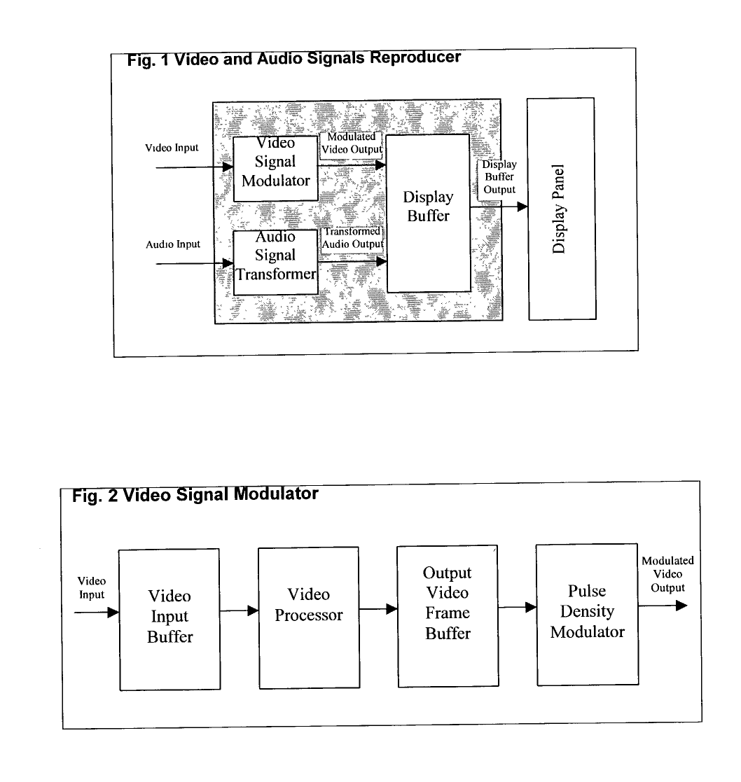

FIG. 1 describes a Video and Audio Signals Reproducer. The Reproducer has 2 data inputs: Video Input and Audio Input and 1 data output: Display Buffer Output. It consists of following parts: Video Signal Modulator, Audio Signal Transformer, and Output Display Buffer. The Reproducer may also have several input and output control signals (not shown here).

FIG. 2 shows details of the Video Signal Modulator. It receives Video Input data and temporally stores data in the Video Input Buffer. The data are going to the Video Processor, which scales it down vertically and horizontally to fit the low-resolution display panel. The Video Input Buffer is required due to necessity to perform the vertical scaling.

The Video Processor may also quantize the video data to decrease number of bits representing the digital values. In a preferred embodiment, when the Video Input Data does not include the luma component, the Video Processor may perform a color space conversion to obtain data for display.

Output from the Video Processor is the scaled down quantized video data representing the luma component of the video signal. These data are arranged in the form of an Output Video Frame Buffer.

The current invention reconciles the multiple-value data from the Output Video Frame Buffer with the requirements for the binary data (only ‘on’ or ‘off’) inside Display Buffer, which drives the low-resolution Display Panel. Physically in some designs, such as Vacuum Fluorescent Display, the Display Buffer can be part of the Display Panel.

The invention uses the so-called Pulse Density Modulation to solve mentioned discrepancy. The Pulse Density Modulation conveys the numerical values by asserting the variable number of pulses in each fixed period of time. This property of Pulse Density Modulation is used to transmit the brightness value of each pixel due to the capacity of human eye to integrate binary (‘on’ or ‘off’) brightness pulses over the time to perceive them as the gray-scaled pixels.

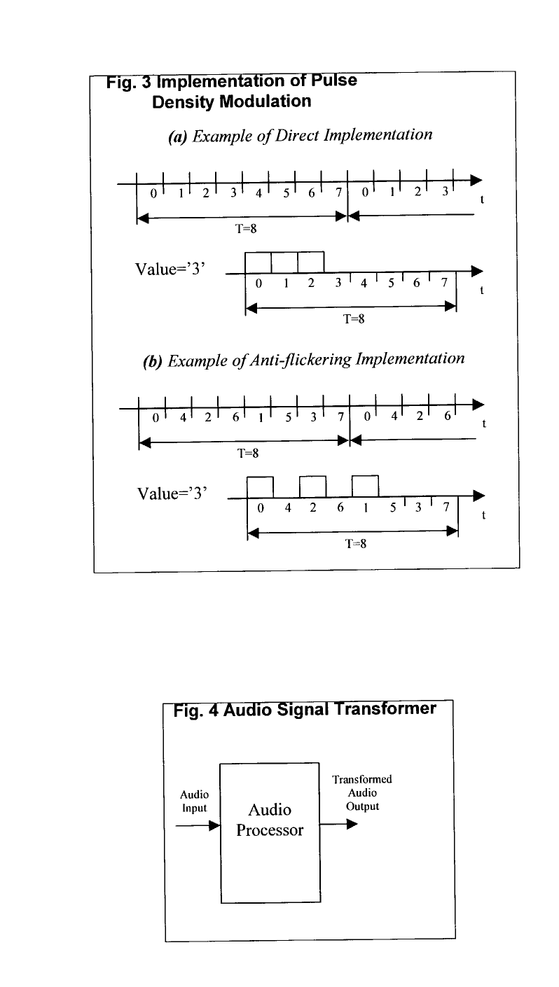

FIG. 3 describes the Pulse Density Modulation implementation. As an example, it is shown the modulation of signals with eight possible distinct values. The period of Pulse Density Modulation is equal to eight to represent the signal values varying from 0 to 7. The set of one ‘on’ pulse and seven ‘off’ pulses represents the ‘zero’ value, and the set of eight consecutive ‘on’ pulses represents the highest ‘seven’ value. The set of eight consecutive ‘off’ pulses is not used in this example otherwise up to nine possible distinct values can be represented with the period equal to eight. The eight positive numbers varying from 0 to 7 can be easily expressed by three-bit values.

The FIG.3 shows two possible implementations of aforementioned modulation. The first one is a direct implementation where three-bit count traditionally goes ‘000’, ‘001’, ‘010’, ‘011’, ‘100’and so on. This implementation creates an annoying visual artifact named “flickering”. To decrease the flickering artifact the second implementation numbers the pulses unconventionally, starting from the most significant bit. Thus, for the eight-level values represented by three bits the count goes ‘000’, ‘100’, ‘010’, ‘110’, ‘001’and so on.

If signal values have 6 bits then the period of Pulse Density Modulation equal to 64 is used to represent the values. Therefore, in order to transmit the NTSC signal with a refresh rate 60 fields per second the Display Panel is refreshed with frequency 64×60=3840 frames per second or approximately 4 KHz.

FIG. 4 describes the Audio Signal Transformer. It receives Audio Input data, which are processed by an Audio Processor. The Audio Processor decimates the audio data samples, quantizes them, and possible transforms them into the logarithmic scale for the simplicity of perceiving. The transformed audio data samples are written as well into Display Buffer, which drives the low-resolution Display Panel. The Audio Processor may separates Audio Data into the left and the right channels, which then are shown on the Display Panel separately.

While a preferred embodiment of the present invention has been shown and described by way of example only, it will be apparent to those skilled in the art that changes and modifications may be made without departing from the scope of the invention, as set out in the appended claims.

We claim:

1. A method for the reproduction of video and audio signals on a low-resolution display panel, comprising the steps of:
a. scaling the video or audio frame to fit the display panel;
b. quantization of the video or audio signals to predetermined level values;
c. temporal representation of video data by using pulse density modulation; and
d. sending the binary data to the display panel.

2. The method of claim 1 including, during step c, the step of anti-flickering signal transformation comprising maximization of separation of pulses during said pulse density modulation.

3. An apparatus for the display of a digital video signal on a low-resolution display panel, comprising:
an interface for receiving said digital video signal;
a video signal modulator connected to said interface for converting said digital video signal into a format suitable for display on a low-resolution display;
a display buffer connected to said video signal modulator; and
a low-resolution display connected to said display buffer.

4. An apparatus for the display of a digital audio signal on a low-resolution display panel, comprising:
an interface for receiving said digital audio signal;
an audio signal transformer connected to said interface for converting said digital audio signal into a format suitable for display on a low-resolution display;
a display buffer connected to said audio signal transformer; and
a low-resolution display connected to said display buffer.

5. An apparatus for the display of a video signal on a low-resolution display panel, comprising:
an interface for receiving said video signal and converting it to a digital video signal;
a video signal modulator connected to said interface for converting said digital video signal into a format suitable for display on a low-resolution display;
a display buffer connected to said video signal modulator; and
a low-resolution display connected to said display buffer.

6. An apparatus for the display of an audio signal on a low-resolution display panel, comprising:
an interface for receiving said audio signal and converting it to a digital audio signal;
an audio signal transformer connected to said interface for converting said digital audio signal into a format suitable for display on a low-resolution display;
a display buffer connected to said audio signal transformer; and
a low-resolution display connected to said display buffer.

7. The apparatus of claim 3 or 5 wherein said video signal modulator further comprises
an input buffer;
a video processor connected to said input buffer for scaling, quantizing, or otherwise processing said digital video data;
an output buffer connected to said video processor; and
a pulse density modulator connected to said output buffer.

8. The apparatus of claim 7 wherein said pulse density modulator implements the count of pulses by incrementing the counting value starting from the most significant bit and ending with least significant bit.

9. The apparatus of claims 4 or 6 wherein an audio signal transformer further comprises an audio processor for scaling, quantizing, or otherwise processing said digital audio signal.

10. The apparatus of claim 4 wherein multiple digital audio signals may be displayed simultaneously on said low-resolution display.

11. The apparatus of claim 6 wherein multiple audio signals may be displayed simultaneously on said low-resolution display.

12. An apparatus for the display of a digital video and at least one digital audio signal on a low-resolution display panel, comprising:
an interface for receiving said digital video signal and said at least one audio signal;
a video signal modulator connected to said interface for converting said digital video signal into a format suitable for display on a low-resolution display;
an audio signal transformer connected to said interface for converting said at least one digital audio signal into a format suitable for display on a low-resolution display;
a display buffer connected to said video signal modulator and said audio signal transformer; and
a low-resolution display connected to said display buffer.

13. An apparatus for the display of a video and at least one audio signal on a low-resolution display panel, comprising:
an interface for receiving said video signal;
a first analog to digital converter connected to said interface for converting said video signal into a digital video signal;
a second analog to digital converter connected to said interface for converting said at least one audio signal into at least one digital audio signal;
a video signal modulator connected to said interface for converting said digital video signal into a format suitable for display on a low-resolution display;
an audio signal transformer connected to said interface for converting said at least one digital audio signals into a format suitable for display on a low-resolution display;
a display buffer connected to said video signal modulator and said audio signal transformer; and
a low-resolution display connected to said display buffer.

14. The apparatus in claim 12 wherein said digital video and said at least one digital audio signal may be displayed on said low-resolution display simultaneously.

15. The apparatus in claim 13 wherein said video and said at least one audio signal may be displayed on said low-resolution display simultaneously.
